(19) United States
(12) Patent Application Publication
(10) Pub. No.: US 2018/0323644 A1
(43) Pub. Date: Nov. 8, 2018

(54) PARTITION-COMPOSTION METHOD FOR ONLINE DETECTION OF TRANSIENT STABILITY AND THE EQUIPMENT THEREOF

(71) Applicant: Tianjin University, Tianjin (CN)

(72) Inventors: Hongjie JIA, Tianjin (CN); Shuai ZHAO, Tianjin (CN); Dazhong FANG, Tianjin (CN); Yuan ZENG, Tianjin (CN); Xiangyu KONG, Tianjin (CN)

(73) Assignee: Tianjin University, Tianjin (CN)

(21) Appl. No.: 15/747,537

(22) PCT Filed: Aug. 28, 2015
(86) PCT No.: PCT/CN2015/088387

§ 371 Date: Jul. 11, 2018

(30) Foreign Application Priority Data
Jul. 28, 2015 (CN) 201510452416.1

(51) Int. Cl. H02J 13/00

(52) U.S. Cl. CPC H02J 13/0006

(57) ABSTRACT

The present invention comprises a partition-composition method and its equipment for online detection of transient stability of interconnected power system. The method consists of three parts. Firstly, according to the dynamic response data of the generators at the actual time, the key parameters of transient stability analysis of local areas can be obtained from local dispatch control center based on the wide area measurement system. Secondly, the key parameters of entire grid can be obtained using the uploaded parameters from the local area. Lastly, using the partition-composition method, parameters of an adjoint power system of the entire grid can be obtained. The equipment consists of 4 modules, including the first obtained module, transport module, the second obtained module and the composition module. Using these modules, transient stability data of entire grid can be obtained exactly without the limitation of network topology, system model and parameters. The present invention can be a beneficial and potential tool for the online analysis of power system transient stability with higher computation speed and lower storage requirement.

### FIELD OF THE INVENTION

The present invention relates to power system, especially to a partition-composition method for online detection of transient stability and the equipment thereof. More specifically, the invention relates to a method and its equipment for online analysis of bulk grid transient stability based on the wide area measurement system.

### BACKGROUND OF THE INVENTION

Transient stability analysis methods based on the offline data have been widely utilized, such as numerical simulation method and direct method. However, the result using above methods is strongly dependent on the offline information such as system model and network topology. The analysis result may be incorrect to response the real dynamic process because of the offline error.

With the application of the wide area measurement system (hereinafter referred to as WAMS), more attentions have been paid on the online transient stability evaluation using WAMS. Angles of generators measured from phasor measurement unit (PMU) have been utilized for the transient stability analysis in several methods, including the phase-plane trajectories analysis method based on transient energy function (TEF) and rotor-angle curve analysis method based on equal area criterion method. These methods can be a beneficial tool for the online analysis based on WAMS without the limitation of the offline data and system parameters.

However, the above methods require the angles of all the generators in the system, which may decrease the quality of transport data and the efficiency of computation process in the bulk grid. Furthermore, due to most local fault only relates to the coherent generators, it may generate vast redundant information when the real data of the entire grid are required. To solve the above problem, coherent equivalence method has been utilized for the simplification of the outside network, which needs more time to extract enough trajectories during the analysis procedure. The accuracy of coherent equivalence method may be affected by the different instability mode of the power system.

In order to solve the above problems, the existing cohomology equivalence method is adopted to simplify and equalize the external network, but the online dynamic equivalence process requires the window track information of a longer time, and the calculation process is complex, and the stability analysis accuracy is affected by the cohomology equivalence method and the instability mode of power system.

### SUMMARY OF THE INVENTION

The present invention provides a partition-composition method for online detection of transient stability of interconnected power system and the equipment thereof, which uses the WAMS data without the limitation of network topology, system model and parameters. The invention is beneficial with simple computational process and high accuracy.

The present invention will be described in detail below.

A partition-composition method for online detection of transient stability of interconnected power system, which includes following steps:

Step 1: acquiring the dynamic response data of nₖ generators in the actual operation time, and obtaining the feature parameters for transient stability analysis of local area grid from the local dispatch control center based on WAMS;

Step 2: uploading feature parameters of all the local area grids to the dispatch control center of the entire grid, and obtaining the parameters for transient stability analysis of entire grid;

Step 3: calculating feature vector of an adjoint power system (hereinafter referred to as APS) of entire grid according to the partition-composition theorem of APS.

Where, dynamic response data include: rotor angle, rotor speed, rotor acceleration, center of inertia (hereinafter referred to as COI), electrical power output and mechanical power.

The feature parameters for transient stability analysis of local area grid include feature vector of APS and feature vector of COI of local area grid.

In particular, feature parameters for transient stability analysis of local area grid also include the sum vector composed of the sum of angle, sum of speed and sum of acceleration of all generators in local area grid.

The feature parameters for transient stability analysis of entire grid include feature vector of APS and feature vector of COI of entire grid.

Wherein, the feature vector of COI of entire grid is the composition of the feature vectors of COI of all the local area grids.

In particular, the step 3 further includes following step:

Obtaining the feature vector of the APS of entire grid by composing the parameters for transient stability analysis and the sum vector for transient stability analysis of entire grid.

A partition-composition equipment for online detection of transient stability of interconnected power system includes following modules:

A first acquisition module, which is utilized for acquiring the dynamic response data of nₖ generators in the actual operation time, and obtaining the feature parameters for transient stability analysis of local area grid from the local dispatch control center based on WAMS;

A transmission module, which is utilized for transmitting feature parameters of transient stability analysis of respective local areas to the dispatch control center of the entire grid;

A second acquisition module, which is utilized for obtaining feature parameters of transient stability analysis of the entire grid;

A composition module, which is utilized for composing the feature vector of the APS of entire grid according to the partition-composition theorem of the APS;

Wherein, the composition module includes:

A composition sub module, which is utilized for composing the feature vector of the APS of entire grid according to the feature parameters and the sum vector of transient stability analysis of the entire grid.

The present invention provides a practical method and equipment available for transient stability analysis of the bulk grid in accordance with the WAMS system, since it is independent with network structure, system model and parameters. Furthermore, the invention has higher precision without calculation error because of the equivalence method, since there is no need for dynamic equivalence and simplification of the local area grid during the transient stability analysis procedure.

The present invention has advantageous in that:

1. The present invention does not need the identification of critical generators, network equivalence or simplification, which keeps the invention independent from the complex instable mode in the bulk grid;

2. The calculation process of the present invention is comparatively less and is not restricted by the network structure, system model and parameters, thus can realize the online transient stability analysis;

3. The present invention is effectively improved the calculation speed and reduce the data storage of the transient stability analysis, which has good practical application prospect in engineering application.

### BRIEF DESCRIPTION OF THE DRAWINGS

FIG. 1 shows the schematic diagram of data transmission and online transient stability analysis based on the partition-composition method; and

FIG. 2 shows the flow chart of the partition-composition method for the online transient stability analysis; and

FIG. 3 shows the schematic diagram of the partition-composition equipment for the online transient stability analysis; and

FIG. 4 shows the diagram of the composition module; and

FIG. 5 shows the topological structure chart of an embodiment system of North China Power Grid; and

FIG. 6 shows the schematic diagram of rotor angle trajectory of all the generators of an embodiment system of North China Power Grid; and

FIG. 7(a) shows the schematic diagram of phase-plane of Beijing-Tianjin-Tangshan Power Grid, Shanxi Power Grid, Southern Hebei Power Grid; and

FIG. 7(b) shows the schematic diagram of phase-plane of Inner Mongolia Power Grid and North China Power Grid.

In which,
1: first acquisition module
2: transmission module
3: second acquisition module
4: composition module
4l: composition sub module

### DETAILED DESCRIPTION OF THE EMBODIMENTS

The present invention will be further described accompanying with the figures.

### Embodiment 1

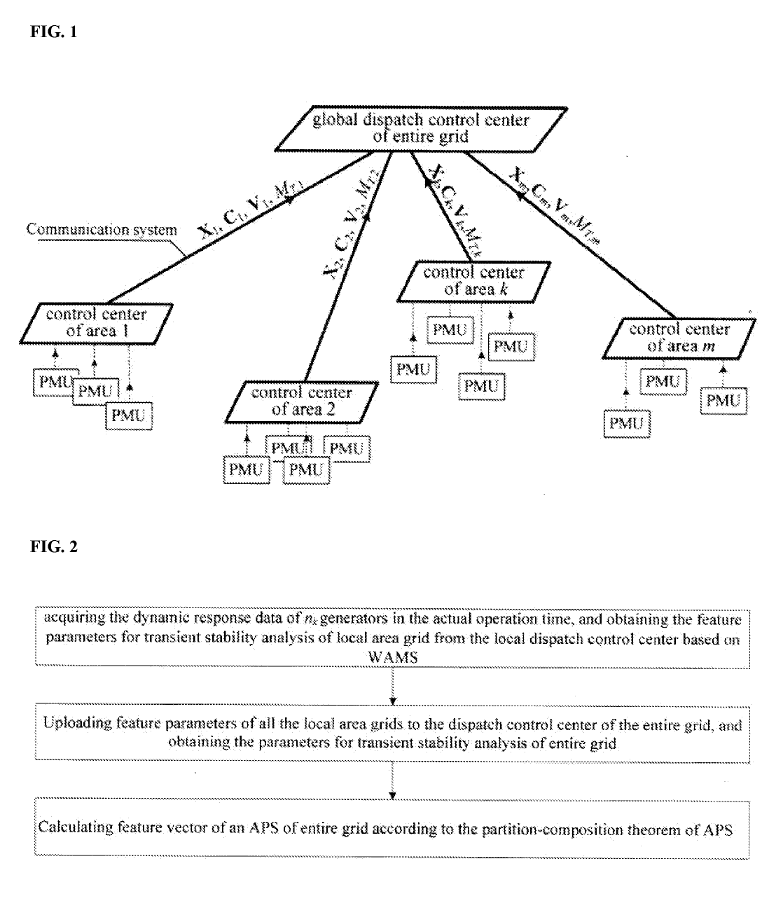

As shown in FIG. 1 and FIG. 2, a partition-composition method for online detection of transient stability includes the following steps:
101: dividing a bulk interconnected power system with n generators into m area grids (A₁, A₂ . . . Aₖ . . . Aₘ) according to their geographical locations or the ownerships, and defining the number of generators in each area grid as nₖ, k=1, 2, . . . , m;
102: In the area grid Aₖ, obtaining dynamic response data of nₖ generators at actual operation time t from WAMS system;
   Wherein, dynamic response data includes: rotor angle δᵢ(rad), rotor speed ωᵢ(rad/s), rotor acceleration aᵢ(rad/s²), inertia constant Mᵢ(s²/rad), electrical power output Pₑᵢ(p.u.) and mechanical power Pₘᵢ(p.u.), which are obtained by PMU of WAMS;
103: calculating feature parameters of transient stability analysis in the local area grid Aₖ based on the WAMS according to the dynamic response data in the local dispatch control center in the local area grid Aₖ, and uploading the feature parameters of transient stability analysis of all the local area grids to the dispatch control center of entire grid, and acquiring the feature parameter of transient stability analysis of entire grid.
   Wherein, in the local area grid Aₖ having nₖ generators, feature parameters for transient stability analysis of local area includes: feature vector Xₖ of APS, feature vector Cₖ of COI, Xₖ=[Rₖ, ω_{θ,k}, α_{s,k}]^{T}; Cₖ=[δ_{COI,k}, ω_{COI,k}, α_{COI,k}]^{T}.

Wherein, Rₖ is the radius of Aₖ of the local area grid, which stands for the swing of rotor angle; ω_{θ,k} is the projection angle speed of Aₖ, which equals the derivative of radius Rₖ to time t; α_{s,k} is the projection acceleration speed of Aₖ, which equals the derivative of ω_{θ,k} to time t, δ_{COI,k}, ω_{COI,k} and α_{COI,k} denote the COI motion vector of local area grid Aₖ.

Furthermore, feature parameters of transient stability analysis in local area also include sum vector Vₖ=[θ_{Σ,k}, [symbol] , α_{Σ,k}]^{T}, which stands for the sum of the angle, speed and acceleration of all generators in the local area grid Aₖ.

In a power system having n generators, parameters of transient stability analysis of entire grid includes: feature vector X of APS, feature vector C of COI in the local area, X=[R, ω_{θ}, αₛ]^{T}; C=[δ_{COI}, ω_{COI}, α_{COI}]^{T}.

Wherein, R is the radius of entire grid, which stands for the swing of rotor angle; ω_{θ} is the projection angle speed of entire grid, which equals the derivative of R to time t; αₛ is the projection acceleration speed of entire grid, which equals the derivative of ω_{θ} to time t, δ_{COI}, ω_{COI} and α_{COI} denote the COI motion vector of entire grid. The calculation of the parameters of the entire grid is identical with those of local area grid Aₖ except the number of generators, so no more detail with be discussed in this embodiment of the present invention.

Through the composition theorem of COI, feature vector C of entire grid can be obtained by composing feature vectors Cₖ of all the local area grids. The composition theorem of COI of entire grid can be expressed as: the feature vector C of the entire grid equals the composition of feature vectors Cₖ of COI of all the local area grids, which satisfies the following equation:

$$C = {\sum }_{k = 1}^{m} \frac{{M}_{T , k}}{{M}_{T}} {C}_{k}$$

Wherein, M_{T,k}, M_{T} stands for the sum of the inertia constant of all the generators in the local area grid Aₖ and in the entire grid, respectively.
104: composing feature vector of an APS of the entire grid according to the partition-composition theorem of APS.

Wherein, the partition-composition theorem of APS can be expressed as: composing the vector X of an entire grid by feature vector Xₖ, sum vector Vₖ, feature vector Dₖ and M_{T,k} of all the local area grids.
105: determining whether the actual operation time t equals the end time tₘₐₓ of transient stability analysis, if yes, ending the procedure; otherwise, setting t=t+Δt, back to step 101 to continue obtaining data of WAMS. Wherein, Δt represents the sampling period of WAMS, end time tₘₐₓ can be initialized according to the practical application.

By performing step 101 to 105, the partition-composition method of the present invention can precisely achieve the transient stability analysis data of the entire grid without the limitation of network structure, power system model and parameters.

### Embodiment 2

As shown in FIG. 1 and FIG. 2, the technical solution in embodiment 1 is further described in detail according to the detailed formulae. The partition-composition method for online detection of transient stability includes the following steps:
201: dividing a bulk interconnected power system with n generators into m local area grids (A₁, A₂ . . . Aₖ . . . Aₘ) according to their geographical locations or the ownerships, and defining the number of generators in each area as nₖ, k=1, 2, . . . , m;
202: obtaining dynamic response data of nₖ generators by PMU of WAMS in the local area grid Aₖ, wherein the dynamic response data includes rotor angle δᵢ(rad), rotor speed ωᵢ(rad/s), rotor acceleration αᵢ(rad/s²), inertia constant Mᵢ(s²/rad), electrical power output Pₑᵢ(p.u.) and mechanical power Pₘᵢ(p.u.), 1=1, 2, 3 . . . nₖ.
203: , calculating the feature parameters of transient stability analysis of the local area grid Aₖ in the dispatch control center, which include feature vector Xₖ of APS, the feature vector Cₖ of COI, and sum vector Vₖ.

Wherein the feature vectors Xₖ and Cₖ can be expressed by the following equations:

$$\begin{matrix}\{ \begin{matrix}{R}_{k} = \sqrt{{\sum }_{i = 1}^{{n}_{k}} {( {δ}_{i} - {δ}_{COI , k} )}^{2}} \\ {ω}_{θ , k} = {\sum }_{i = 1}^{{n}_{k}} \frac{( {δ}_{i} - {δ}_{COI , k} ) ( {ω}_{i} - {ω}_{COI , k} )}{{R}_{k}} \\ {α}_{s , k} = {\sum }_{i = 1}^{{n}_{k}} \frac{( {δ}_{i} - {δ}_{COI , k} ) {α}_{i}}{{R}_{k}} + \frac{{\sum }_{i = 1}^{{n}_{k}} {( {ω}_{i} - {ω}_{COI , k} )}^{2} - {ω}_{θ , k}^{2}}{{R}_{k}}\end{matrix} & ( 1 ) \\ \{ \begin{matrix}{δ}_{COI , k} = \frac{1}{{M}_{T , k}} {\sum }_{i = 1}^{{n}_{k}} {M}_{i} {δ}_{i} \\ {ω}_{COI , k} = \frac{1}{{M}_{T , k}} {\sum }_{i = 1}^{{n}_{k}} {M}_{i} {ω}_{i} \\ {α}_{COI , k} = \frac{{\sum }_{i = 1}^{{n}_{k}} ( {P}_{mi} - {P}_{ei} )}{{M}_{T , k}}\end{matrix} & ( 2 )\end{matrix}$$

Where,

$${M}_{T , k} = {\sum }_{i = 1}^{{n}_{k}} {M}_{i} ,$$

Mᵢ is the inertia constant of i^{th} generator.

In particular, feature parameters of transient stability analysis of the local area grid Aₖ also include the sum of the angle, the sum of the speed and the sum of the acceleration of all generators in Aₖ, which can be expressed as Vₖ=[θ_{Σ,k}, [symbol] , α_{Σ,k}]^{T} and can be calculated as follows:

$$\{ \begin{matrix}{θ}_{Σ , k} = {\sum }_{i ∈ {A}_{k}} ( {δ}_{i} - {δ}_{COI , k} ) ; \\ {ω}_{Σ , k} \% = \frac{d {θ}_{Σ , k}}{dt} = {\sum }_{i ∈ {A}_{k}} ( {ω}_{i} - {ω}_{COI , k} ) \\ {α}_{Σ , k} = \frac{d {ω}_{Σ , k} \%}{dt} = {\sum }_{i ∈ {A}_{k}} {α}_{i}\end{matrix} \qquad ( 3 )$$

In particular, vectors Xₖ, Cₖ, Vₖ and M_{T,k} in each local are grid can be transmitted to the dispatch control center of entire grid to calculate the feature parameters of entire grid.
204: composing feature vectors Cₖ of COI of all the local area grids into the feature vector C of entire grid according to the composition theorem of COI;

Wherein, the feature vector C of the entire grid equals the composition of the feature vectors Cₖ of all the local area grids, which can be expressed by the following equation:

$$C = {\sum }_{k = 1}^{m} \frac{{M}_{T , k}}{{M}_{T}} {C}_{k} \qquad ( 4 )$$

205: composing feature vector of an APS of entire grid by the partition-composition theorem of APS.

The feature vector X of an entire grid can be composed with the vectors Xₖ, Vₖ, Dₖ and M_{T,k} of all the local area grids, which is expressed by the following equations:

$$\{ \begin{matrix}R = \sqrt{{\sum }_{k = 1}^{m} ( {R}_{k}^{2} + {n}_{k} {l}_{k}^{2} + 2 {l}_{k} {θ}_{Σ , k} )} \\ {ω}_{θ} = \frac{1}{R} {\sum }_{k = 1}^{m} ( {R}_{k} {ω}_{θ , k} + {n}_{k} {l}_{k} {ω}_{k} + {ω}_{k} {θ}_{Σ , k} + {l}_{k} {\tilde{ω}}_{Σ , k} ) \\ {α}_{s} = \frac{1}{R} [ {\sum }_{k = 1}^{m} ( {ω}_{θ , k}^{2} + {R}_{k} {α}_{s , k} + {n}_{k} {ω}_{k}^{2} + {n}_{k} {l}_{k} {α}_{k} + {α}_{k} {θ}_{Σ , k} + 2 {ω}_{k} {\tilde{ω}}_{Σ , k} + {l}_{k} {α}_{Σ , k} ) ] + \frac{- {ω}_{θ}^{2}}{R}\end{matrix} \qquad ( 5 )$$

Wherein, Dₖ=[lₖ, ωₖ, αₖ]^{T}, which is the feature vector representing the distance, speed and acceleration from COIₖ of local area grid Aₖ to COI of entire grid, the vectors therein can be calculated by the following equations:

$$\{ \begin{matrix}{l}_{k} = {δ}_{COI , k} - {δ}_{COI} \\ {ω}_{k} = \frac{{dl}_{k}}{dt} = {ω}_{COI , k} - {ω}_{COI} \\ {α}_{k} = \frac{d {ω}_{k}}{dt} = {α}_{COI , k} - {α}_{COI}\end{matrix} \qquad ( 6 )$$

Combining the equation into matrix as: Dₖ=Cₖ−C.
206: determining whether the actual operation time t equals the end time tₘₐₓ of transient stability analysis, if yes, ending the procedure; otherwise, setting t=t+Δt, back to step 201 to continue obtaining data of WAMS.

According to step 201 to 206, the partition-composition method of the present invention can precisely achieve the transient stability analysis data of the entire grid without the limitation of network structure, power system model and parameters.

### Embodiment 3

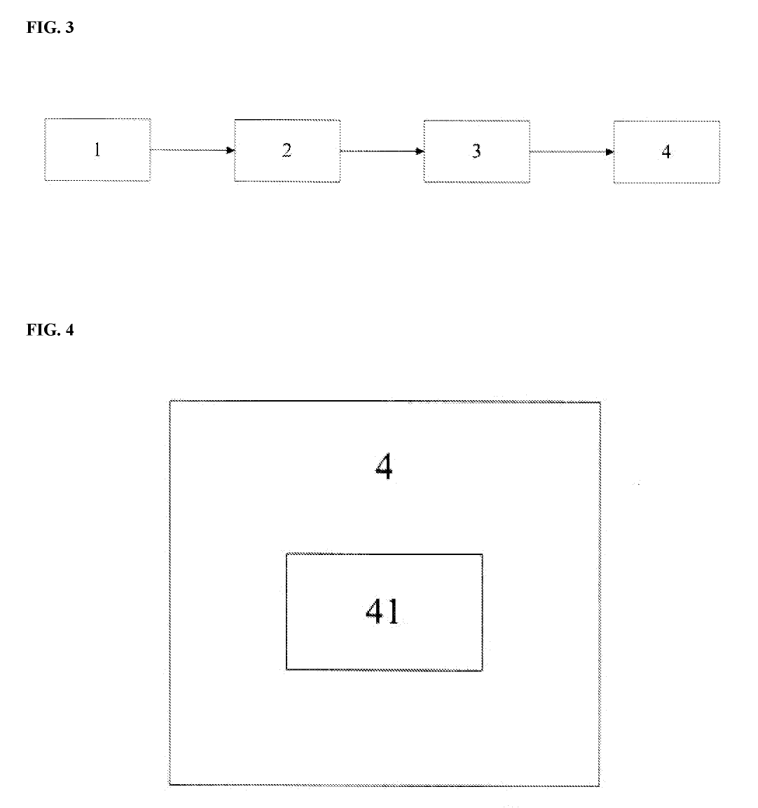

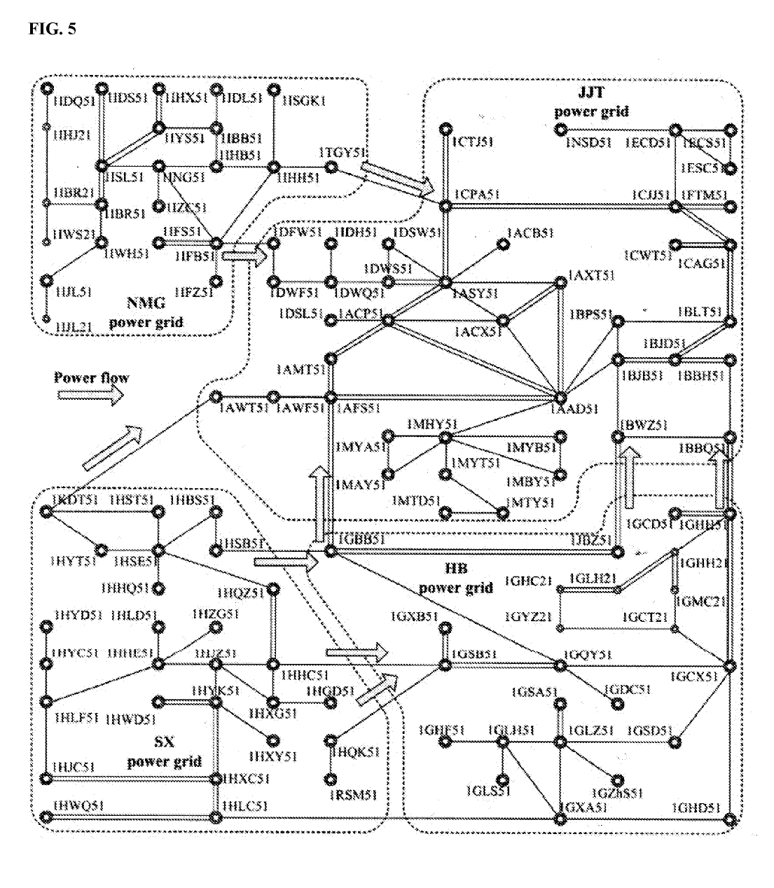

As shown in FIG. 3 and FIG. 4, a partition-composition equipment for online detection of transient stability of interconnected power system includes following modules:

A first acquisition module 1, which is utilized for acquiring the dynamic response data of nₖ generators in the actual operation time, and obtaining the feature parameters for transient stability analysis of local area grid from the local dispatch control center based on WAMS;

A transmission module 2, which is utilized for transmitting feature parameters of transient stability analysis of respective local areas to the dispatch control center of the actual entire grid;

A second acquisition module 2, which is utilized for obtaining feature parameters of transient stability analysis of the entire grid;

A composition module 4, which is utilized for composing the feature vector of the APS of entire grid according to the partition-composition theorem of APS;

Wherein, the dynamic response data include: rotor angle, rotor speed, rotor acceleration, inertia constant, electrical power output and mechanical power of the generators.

Wherein, the feature parameters for transient stability of local area grid include:

Feature vector of the APS and feature vector of COI of each local area grid.

In particular, feature parameters for transient stability analysis of local area grids also include the sum vector composed of the sum of angle, sum of speed and sum of the acceleration of all generators in the local area grid.

Wherein, the feature parameters for transient stability of entire grid include: Feature vector of the APS and feature vector of COI of entire grid.

In particular, the feature vector of COI of entire grid is the composition of the feature vectors of COI of all the local area grids.

Furthermore, as shown in FIG. 4, the composition module 4 includes:

A composition sub module 41, which is utilized for composing the feature vector of the APS of entire grid according to the feature parameters and the sum vector of transient stability analysis of entire grid.

When used in practice, the modules and sub module can be realized by the single chip microcomputer, PC and other devices with calculation function, and the embodiment of the present invention does not limit the model and type of the devices.

By applying the first acquisition module 1, transmission module 2, the second acquisition module 3 and the composition module 4, the equipment of the present invention can precisely achieve the transient stability analysis data of the entire grid without the limitation of network structure, power system model and parameters.

### Embodiment 4

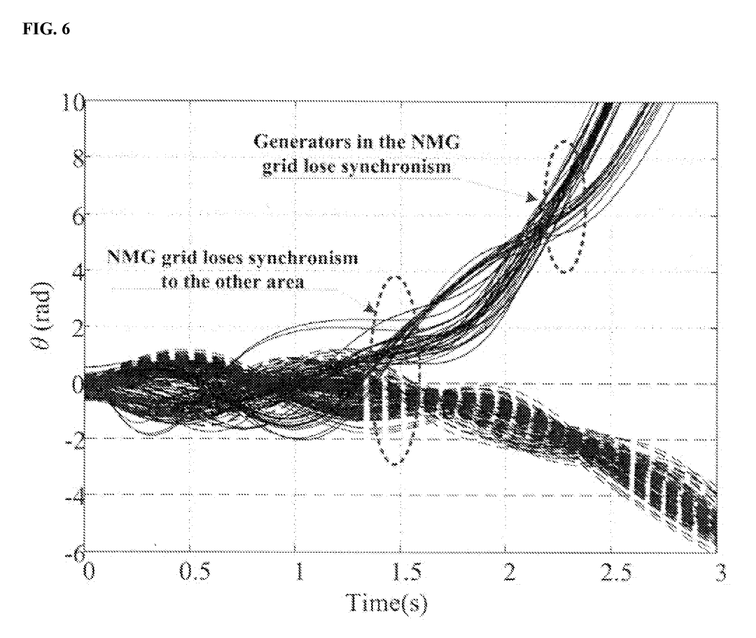

The operation flow and actual effectiveness can be illustrated below with the embodiment. The embodiment made a simulation analysis on the North China Power Grid, FIG. 5 shows the topological structure chart of an embodiment system of North China Power Grid. As shown in FIG. 5, circle points represent the bus nodes of power system, such as the node connecting the bus 1IFB51 and bus 1DFW51; solid lines represent the lines of power system, such as line 1IFB51-1DFW51; the hollow arrows represent the power flow direction. Data of WAMS are simulated by transient simulation and the simulation step width is 0.01 s. The embodiment verifies the correctness and effectiveness of the present method through a dynamic process stimulated by a fault occurred on the transmission lines between local areas and by calculating the phase plane of (R, ω_{θ}) of the APS. The fault is occurred on line “1IFB51-1DFW51” with three-phase short circuit in 0 s, and the fault lasts for 0.14 s. FIG. 6 shows the schematic diagram of rotor angle trajectory of all the generators of an embodiment system of North China Power Grid. As shown in FIG. 6, after the fault clearing, it is obvious that the power system first appeared interval instability, i.e. Inner Mongolia power grid lost stability corresponding to the main power system, and then the Inner Mongolia grid lost stability subsequently.

Firstly, calculation steps of the present invention according to FIG. 5 to FIG. 7 are as follows:

Step 1: according to the geographical locations and ownership, dividing North China Power Grid with 288 generators into 4 local area grids as shown in FIG. 5, which are Beijing-Tianjin-Tangshan Power Grid (short for JJT power grid), Shanxi Power Grid (short for SX power grid), Southern Hebei Power Grid (short for HB power grid), and Inner Mongolia power grid (short for NMG power grid); and the local areas, which are connected with each other by a plurality of transmission lines, are divided by dotted lines. For example, NMG and JJT power grid are connected with each other by two transmission lines of line 1IFB51-1DFW51 and line 1TGY51-1CPA51.

Step 2: obtaining dynamic response data of nₖ generators at actual operation time t from each local area of WAMS system. Wherein, the dynamic rotor angle trajectories of all the generators are shown in FIG. 6.

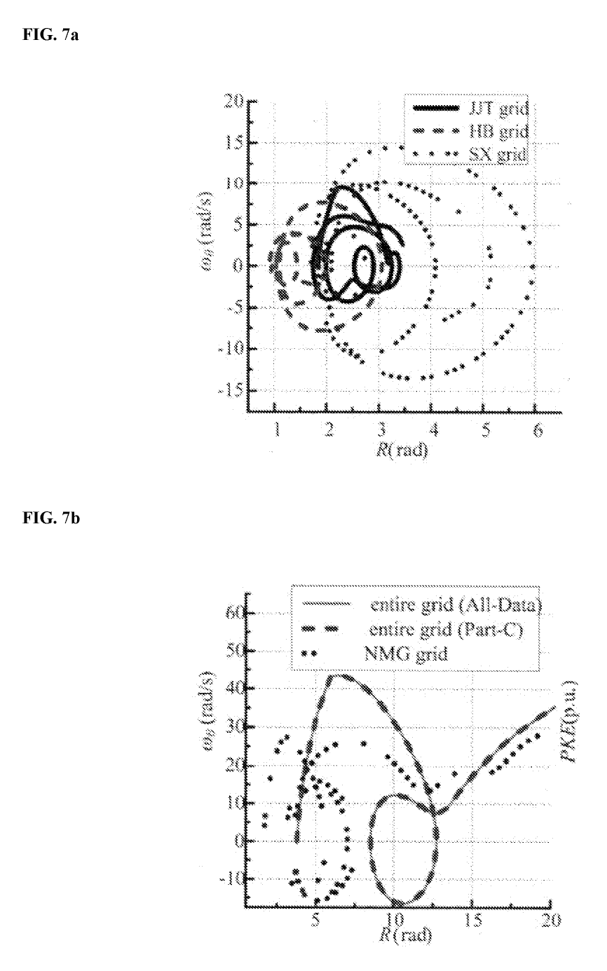

Step 3: calculating the feature parameters of transient stability analysis of the local area grid in the dispatch control center, and the result thereof are shown in FIGS. 7(a) and 7(b). Then, the feature parameters of all the local areas are uploaded to the dispatch control center of the entire grid to calculate the feature parameters of transient stability analysis of entire grid.

Step.4: composing feature vectors Cₖ of COI of all the local area grids into the feature vector C of entire grid according to the composition theorem of COI; And composing the feature vector of an APS of entire grid by the partition-composition theorem of APS.

The calculation results by using the partition-composition method are shown in FIG. 7(b). It can be seen that the result calculated by partition-composition method of the present invention is identical with the dynamic curves calculated by all the generators in the entire grid, which verifies the correctness and effectiveness of the present method. In addition, as shown in FIG. 7(a), JJT power grid, SX power grid, and HB power grid keep the stability of respective phase-planes, i.e. maintain the rotor angle transient stability; whereas, the result calculated by partition-composition method of the present invention, the all-data result and the result calculated in NMG power grid show that the instability of power system is occurred, it can be seen that the generators in the entire grid appeared instability, i.e. the local area grid appeared instability, and then the inner of NMG power grid appeared instability. The stability analysis results of phase-planes shown in FIG. 7 (a) and FIG. 7(b) are consistent with the rotor angle trajectory of all the generators, which shows that the transient stability analysis can be achieved by the present invention.

Furthermore, the calculation efficiencies and data storage efficiency of the present invention are shown in Table 1 and Table 2:

TABLE 1
Calculation efficiencies comparison of North China Power Grid

| | | | | | | Partition-composition method | |
|---|---|---|---|---|---|---|---|
| | All-Data method | | | | | Entire grid | |
| | Entire | | | | NMG | partition-composition | |
| | grid | JJT grid | HB grid | SX grid | grid | method | Total |
| Time(s) | 0.1004 | 0.0462 | 0.0452 | 0.0451 | 0.0433 | 0.0062 | 0.0524 |

TABLE 2
Data storage efficiencies comparison of North China Power Grid

| | | Partition-composition |
|---|---|---|
| | All-Data method | method |
| Storage | 10.547 MB | 337.5 KB |

Table 1 shows the calculation efficiencies of All-Data method and partition-composition method, without the consideration of the transmission delay, the time of data pre-processing and saving. It can be seen that the calculation time by applying All-Data method requires about 0.1004 s, the calculation time for the four areas by partition-composition method is about 0.0524 s, wherein, the time consumption of partition-composition method only takes 0.0062 s. Obviously, Partition-composition method of the present invention can effectively improve the calculation efficiency.

Table 2 shows the data storage efficiencies comparison of North China Power Grid. The All-Data method requires storing the vectors δi, ωi, Pₘᵢ and Pₑᵢ of each generator, whereas the partition-composition method only needs storing the vectors Xk, Ck and Vk. As shown in table 2, apply All-Data method occupies over 10 MB storage space, whereas the partition-composition method occupies 337.5 KB, which is just 3.2% storage space of the All-Data method. It is well known that the less data is stored, the less communication consumption is required. Therefore, the storage capacity and the communication burden in WAMS system for stability assessment could be remarkably reduced when applying the partition-composition method.

It will be understood by those skilled in the art that the drawings are merely illustrative of a preferred embodiment, and that the serial No. of the embodiments of the present invention are for illustrative purpose only and are not indicative of ranking.

The foregoing specific implementations are merely illustrative but not limiting. A person of ordinary skill in the art may make any modifications, equivalent replacements and improvements under the teaching of the present invention without departing from the purpose of the present invention and the protection scope of the appended claims, and all the modifications, equivalent replacements and improvements shall fall into the protection scope of the present invention.

1-10. (canceled)

11. A partition-composition method for online detection of transient stability of interconnected power system, including following steps:
Step 1: acquiring the dynamic response data of nₖ generators in the actual operation time, and obtaining the feature parameters for transient stability analysis of local area grid from the local dispatch control center based on WAMS;
Step 2: uploading feature parameters of all the local area grids to the dispatch control center of the entire grid, and obtaining the parameters for transient stability analysis of entire grid;
Step 3: calculating feature vector of an adjoint power system (hereinafter referred to as APS) of entire grid according to the partition-composition theorem of APS;
wherein, the partition-composition theorem of APS can be expressed as:
composing the vector X of an entire grid by feature vector Xₖ, sum vector Vₖ, feature vector Dₖ and M_{T,k} of all the local area grids.

12. The partition-composition method for online detection of transient stability of interconnected power system according to claim 11, wherein the dynamic response data include: rotor angle, rotor speed, rotor acceleration, center of inertia (hereinafter referred to as COI), electrical power output and mechanical power.

13. The partition-composition method for online detection of transient stability of interconnected power system according to claim 11, wherein the feature parameters for transient stability analysis of local area grid include feature vector of APS and feature vector of COI of local area grid.

14. The partition-composition method for online detection of transient stability of interconnected power system according to claim 11, wherein the feature parameters for transient stability analysis of local area grid further include the sum vector composed of the sum of angle, sum of speed and sum of acceleration of all generators in the local area grid.

15. The partition-composition method for online detection of transient stability of interconnected power system according to claim 11, wherein the feature parameters for transient stability analysis of entire grid include feature vector of APS and feature vector of COI of entire grid.

16. The partition-composition method for online detection of transient stability of interconnected power system according to claim 15, wherein the feature vector of COI of entire grid is the composition of the feature vectors of COI of all the local area grids.

17. The partition-composition method for online detection of transient stability of interconnected power system according to claim 14, wherein the step 3 further includes the step of:
obtaining the feature vector of the APS of entire grid by composing the parameters for transient stability analysis and the sum vector for transient stability analysis of entire grid.

18. A partition-composition equipment for online detection of transient stability of interconnected power system includes following modules:
a first acquisition module, which is utilized for acquiring the dynamic response data of nₖ generators in the actual operation time, and obtaining the feature parameters for transient stability analysis of local area grid from the local dispatch control center based on WAMS;
a transmission module, which is utilized for transmitting the feature parameters of transient stability analysis of all the local areas to the dispatch control center of the entire grid;
a second acquisition module, which is utilized for obtaining feature parameters of transient stability analysis of the entire grid;
a composition module, which is utilized for composing the feature vector of the APS of entire grid according to the partition-composition theorem of the APS;
wherein, the partition-composition theorem of APS can be expressed as: composing the vector X of an entire grid by feature vector Xₖ, sum vector Vₖ, feature vector Dₖ and M_{T,k} of all the local area grids.

19. The partition-composition equipment for online detection of transient stability of interconnected power system according to claim 18,
wherein the feature parameters of transient stability of the local area grid include:
feature vector of the APS and feature vector of COI of the local area grid;
the feature parameters of transient stability of the local area grid further include:
sum vector composing of the sum of the angle, the sum of speed and the sum of acceleration of all generators in the local area grid.

20. The partition-composition equipment for online detection of transient stability of interconnected power system according to claim 18,
wherein the feature parameters of transient stability of the entire grid include:
feature vector of the APS and feature vector of COI of the entire grid;
in particular, the feature vector of COI of the entire grid is the composition of the feature vectors of COI of all the local area grids;
the composition module includes:
a composition sub module, which is utilized for composing the feature vector of the APS of entire grid according to the feature parameter and the sum vector of transient stability analysis of the entire grid.

21. The partition-composition method for online detection of transient stability of interconnected power system according to claim 13, wherein the feature parameters for transient stability analysis of local area grid further include the sum vector composed of the sum of angle, sum of speed and sum of acceleration of all generators in the local area grid.

22. The partition-composition method for online detection of transient stability of interconnected power system according to claim 12, wherein the feature parameters for transient stability analysis of entire grid include feature vector of APS and feature vector of COI of entire grid.

23. The partition-composition method for online detection of transient stability of interconnected power system according to claim 13, wherein the feature parameters for transient stability analysis of entire grid include feature vector of APS and feature vector of COI of entire grid.

24. The partition-composition equipment for online detection of transient stability of interconnected power system according to claim 19,
wherein the feature parameters of transient stability of the entire grid include:
feature vector of the APS and feature vector of COI of the entire grid;
in particular, the feature vector of COI of the entire grid is the composition of the feature vectors of COI of all the local area grids;
the composition module includes:
a composition sub module, which is utilized for composing the feature vector of the APS of entire grid according to the feature parameter and the sum vector of transient stability analysis of the entire grid.
